(19) United States
(12) Patent Application Publication
(10) Pub. No.: US 2025/0069481 A1
(43) Pub. Date: Feb. 27, 2025

(54) COMPUTER-IMPLEMENTED METHOD AND SYSTEM FOR RATING POKER PLAYERS ACCORDING TO SKILL

(71) Applicants: Eli Sompo, Jerusalum (IL); Aharon Malachi, Jerusalum (IL)

(72) Inventors: Eli Sompo, Jerusalum (IL); Aharon Malachi, Jerusalum (IL)

(21) Appl. No.: 18/811,665

(22) Filed: Aug. 21, 2024

Related U.S. Application Data
(60) Provisional application No. 63/520,817, filed on Aug. 21, 2023.

(51) Int. Cl. G07F 17/32

(52) U.S. Cl. CPC G07F 17/3276; G07F 17/3209; G07F 17/3237; G07F 17/3293

(57) ABSTRACT

According to an aspect of the present invention, there is provided a computer-implemented method for rating poker players according to skill, comprising: receiving, from an input/output device associated with a player computer terminal, one or more inputs from the player; storing, in a computer memory, performance information for the player; calculating, by a processor, one or more corresponding metrics for a rating of the skill of the player; displaying, on a graphical user interface at the player computer terminal, the rating of the skill of the player; and matching the player to a poker game based on the rating of the skill of the player.

### BACKGROUND

Poker is a well-known card game that comes in many variations. A feature common to most poker games is that the ranking of the final hands is based on poker hand ranking. A typical poker hand ranking, from highest to lowest by poker hand category, is: Royal Flush, Straight Flush, Four-of-a-Kind, Full House, Flush, Straight, Three-of-a-Kind, Two Pair, One Pair, and Highest Card in Hand. Often 2-10 players compete in a communal format to see who has the highest hand, although single-player games involving e.g., video poker terminals are also common.

Sometimes poker games take place at a venue, such as a casino, where all of the players physically gather together to participate. Often internet-based poker games are organized as well and played utilizing home computers or mobile devices and web-browsers or mobile applications. These games allow geographically disparate players to participate in poker games without having to travel to a particular venue.

### SUMMARY OF INVENTION

Therefore, the present invention can be implemented either in a poker game where all of the players are physical gathered on an adjacent computerized device or in an internet-based poker game.

While there is an element of luck involved in poker in the short run, over the longer run of many hands poker is considered to be a game of skill. Elements of skill include bet sizing, decisions to fold a hand, and decisions about how many cards to draw (in some poker games which involve the replacement of cards from a hand; other poker games like Texas Hold 'Em do not involve replacing cards in a player's hand, but do nonetheless involve the other elements of skill listed above). Human players vary widely in their ability to play poker, from those just learning the rules to those who regularly win professional competitions involving millions of dollars in prize money. Poker players might desire to play against other pokers of similar skill in order to increase their enjoyment of the game; however, it can be difficult to determine which other players are of similar skill.

Accordingly, an aspect of the present invention provides computer-implemented method for rating poker players according to skill, comprising: receiving, from an input/output device associated with a player computer terminal, one or more inputs from the player; storing, in a computer memory, performance information for the player; calculating, by a processor, one or more corresponding metrics for a rating of the skill of the player; displaying, on a graphical user interface at the player computer terminal, the rating of the skill of the player; and matching the player to a poker game based on the rating of the skill of the player.

According to another aspect of the present invention, there is provided a system, comprising: at least one input/output device(s) associated with and communicatively connected to a poker player computer terminal; a poker player computer terminal with a graphical user interface (GUI); a server; a database stored on a computer-readable medium; and at least one processor arranged to: receive, from an input/output device associated with a player computer terminal, one or more inputs from the player; store, in a computer memory, performance information for the player; calculate, by a processor, one or more corresponding metrics for a rating of the skill of the player; display, on a graphical user interface at the player computer terminal, the rating of the skill of the player; and match the player to a poker game based on the rating of the skill of the player.

### BRIEF DESCRIPTION OF THE DRAWINGS

FIG. 1 illustrates a graphical user interface displaying a rating of a player and a listing of games suitable for the player's rating.

### DETAILED DESCRIPTION

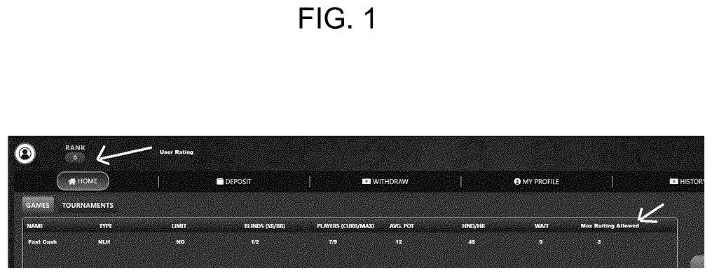

FIG. 1 illustrates rating a player according to skill and providing a list of games and/or tournaments in which the player's skill rating is acceptable. In this example, there is a maximum rating for a game of 3, limiting the skill level of players in that game to skill ratings of 3 or lower.

The exemplary embodiment contemplates calculating a player's skill rating by measuring the player's win/loss record over a period of time in the games in which the player participates and defining the player's performance information according to the player's win/loss record as well as the ratings for the opposing players in the same games as the player. A player's rating thus can depend on the player's record and the records of the player's opponents; better records for the player and the player's opponents will lead to higher ratings.

Thus, a player's rating will be higher if the player wins games against relatively higher-ranked players than if the player wins games against relatively lower-ranked players. Generally a player's rating continues to rise as long as the player consistently wins against other highly-rated players. Wins against lower-ranked players will not cause a player's rating to continue to rise.

Different rating systems can be used for various game types. There are a wide variety of poker games and a player's performance can be measured specific to the various game types. A separate system can also be used to track player performance in poker tournaments based on the results of the tournaments and the ratings of the other players participating in the tournaments.

Other embodiments of the present invention will engage in a variety of means to measure and rate a player's skill level. For example, a simpler system tracking numbers and percentages of hands won and lost without reference to the ratings of other players can be used. A player's decisions to fold hands can provide insight into a player's skill and can be used for ranking. Monetary winnings and losings can also be tracked, measured, and used as part or all of a skill rating. Decisions to raise the betting stakes or call a bet can also be used as performance information.

Performance information for a player can be stored in a computer memory and compared to performance information for other players in a database. A variety of schemes are possible for calculating, by a computer processor, metrics for a rating of the skill of the player, with different embodiments weighting different types of performance information differently.

After compiling the performance information and calculating corresponding skill ratings according to the formula of the embodiment, embodiments can display, on a graphical user interface at the player computer terminal, the rating of the skill of the player. It is possible to display a change in the player's rating over time as well to enable a player to gauge his or her progress as a poker player.

A variety of uses of poker player rating information is possible. It could possible to give players insight on the formulation of their rating so that they can become aware of areas of poker strategy in which there is room for improvement. A player could for example learn that the player is not folding enough hands, or is not raising aggressively enough to be judged as a higher-skill player, and further drill-down could be possible into what types of hands the player should be folding more often in order to be considered as a higher-skill player.

An important use of poker player rating information contemplated in embodiments is matching players to a poker games and/or tournaments based on the ratings of the skill of the players. Poker games and/or tournaments could have minimum skill levels, maximum skill levels, or both (establishing lower and upper bounds on the range of skill levels permitted in the game or tournament).

The embodiments described above are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for rating poker players according to skill, comprising:
receiving, from an input/output device associated with a player computer terminal, one or more inputs from the player;
storing, in a computer memory, performance information for the player;
calculating, by a processor, one or more corresponding metrics for a rating of the skill of the player;
displaying, on a graphical user interface at the player computer terminal, the rating of the skill of the player; and
matching the player to a poker game based on the rating of the skill of the player.

2. The method of claim 1, wherein storing performance information for the player comprises:
retrieving ratings for opposing players in the same games as the player;
measuring the player's win/loss record over a period of time in those games; and
defining the player's performance information according to the player's win/loss record and the ratings for the opposing players in the same games as the player.

3. The method of claim 1, wherein the stored performance information comprises placement results in poker tournaments.

4. The method according to claim 1, wherein the performance information comprises monetary winnings and losings.

5. The method according to claim 1, wherein the performance information comprises numbers of hands won and lost.

6. The method according to claim 1, wherein the performance information comprises decisions to fold.

7. The method according to claim 1, wherein the performance information comprises decisions to raise the betting stakes.

8. A system, comprising:
at least one input/output device(s) associated with and communicatively connected to a poker player computer terminal;
a poker player computer terminal with a graphical user interface (GUI);
a server;
a database stored on a computer-readable medium; and
at least one processor arranged to:
receive, from an input/output device associated with a player computer terminal, one or more inputs from the player;
store, in a computer memory, performance information for the player;
calculate, by a processor, one or more corresponding metrics for a rating of the skill of the player;
display, on a graphical user interface at the player computer terminal, the rating of the skill of the player; and
match the player to a poker game based on the rating of the skill of the player.

9. The system of claim 5, further comprising:
a communications link to one or more additional computer terminals belonging to other players in the poker game.

10. The system of claim 5, further comprising a dealer computer terminal displaying information about the poker player.

11. The system of claim 5, wherein the input/output device is a keyboard.

12. The system of claim 5, wherein the input/output device is a mouse.

13. The system of claim 5, wherein the input/output device is a touchscreen.
